(19) United States
(12) Patent Application Publication
(10) Pub. No.: US 2003/0032447 A1
(43) Pub. Date: Feb. 13, 2003

(54) Conversation rewind

(75) Inventor: Willem Bulthuis, Mountain View, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/927,592

(22) Filed: Aug. 10, 2001

(51) Int. Cl. H04M 1/00

(52) U.S. Cl. 455/556; 455/557

(57) ABSTRACT

A consumer electronics device, such as a cell phone, is designed to record all real time communications occurring on it. Recording is started when a communication is initiated, either by the user making or accepting a call. Recordings are stored and organized for ease of retrieval. Recordings can be forwarded to a remote user.

### RELATED APPLICATIONS

The following related applications are incorporated herein by reference:

U.S. patent application Ser. No. 09/464,855 filed Dec. 16, 1999 (Attorney docket no. PHA 23,875), inventors Willem Bulthuis et al.; “HAND-EAR USER INTERFACE FOR HAND-HELD DEVICE”;

U.S. patent application Ser. No. 09/780,229 FILED Feb. 9, 2001 (Attorney docket no. US018001, inventor Rik Sagar, “RAPID RETRIEVAL USER INTERFACE DESIGNED AROUND SMALL DISPLAYS AND FEW BUTTONS FOR SEARCHING LONG SORTED LISTS”;

U.S. patent application Ser. No. 09/642,713 filed Aug. 21, 2000 (Attorney docket no. US 000213), inventor Leila Kaghazian, “SELECTIVE SENDING OF PORTIONS OF ELECTRONIC CONTENT”.

### BACKGROUND OF THE INVENTION

1. Field of the Invention

The invention relates to the field of recording real-time communications, especially in the consumer electronics field.

2. Related Art

In the telephonic arts, it is known to record voice mail when the person being called does not answer the phone. The 911 services (“911” is the national number in the U.S. for emergence calls) also record telephone conversations as part of their service. However, recording services are not sufficiently flexible to accommodate all user needs.

### SUMMARY OF THE INVENTION

It is desirable to provide additional recording functionality for real-time communication.

Advantageously this is achieved by automatically recording real-time communication in response to a user initiating or accepting the real-time communication. Advantageously, the stored communications can serve as a memory aid, or as an opportunity to forward copies of a conversation to additional individuals. For example, the user may want to store the communications at a home server, or the user may want to have the communications automatically transcribed and stored or forwarded as text files, etc. As another example, such automatic recording provides an advantage to the user of a mobile phone. Instead of taking notes or taking action while communicating in real-time, e.g., while driving, the user can postpone these activities to a more convenient moment as the recording is going to be available. The invention therefore records real time communications and stores them as data to enable people or data processing systems to retrieve them. This is a helpful feature, e.g., to find back information about past events addressed in the communication recorded, to determine or verify a certain context wherein certain events took place, etc. It has been known to record telephone conversations, e.g., by emergency services (“dial 911”) and law officers. The invention, however, addresses the consumer functionality that preferably is integrated with the communication device such as a mobile phone, or with the communication service provided to consumers by the service providers.

More specifically, the invention relates to a consumer electronics communication device. The device has a first functionality adapted to enable real-time communication via the device; and a second functionality to enable automatic recording, e.g., by default, of the real time communication in response to a user of the device initiating or accepting the real time communication. Preferably, the first functionality comprises at least one user interface mechanism for providing real-time audio and/or visual information to a user and to receive real-time audio and/or visual information from the user. Preferably, the device comprises a user input to enable the user to select a portion of the real-time communication for the recording. For example, while the user is discussing an issue via the device with another party, the user wants to store, for use later on, a specific piece of information being brought up in the discussion, e.g., a telephone number being mentioned, navigation directions, a street address, etc. The user then asks the other party to repeat that piece of information. While the user holds down a “record” key on the device, the repeated piece of information gets recorded.

Preferably, the device comprises at least one organizational mechanism for organizing the recorded communications in a retrievable form for the user. The organization is based on, e.g., time of the day at which the communication got recorded, caller-ID, or another criterion.

The device preferably has an onboard storage for storing the recorded communication. For example, the device has a solid state memory card/module or a HDD module with a small form factor that stores a copy of the communication or conversation conducted in real time. The module is preferably removable and useable with, e.g., a laptop or desktop PC.

In another embodiment of the invention, the device has an output for transmitting a signal to a storage, the signal being representative of the real time communication for being recorded at the storage. The device is connected via a wire or in a wireless fashion with the storage. For example, the device has a mobile telephone and the storage comprises a separate module that communicates with the mobile telephone using Bluetooth or another short-range communication protocol. The storage module can be kept in a suitcase or carried in another convenient place, so that the weight or shape does not interfere or hamper usage of the phone.

The device preferably comprises an opt-out mechanism in order to exempt a particular communication from being recorded. For example, the opt out mechanism comprises a prompter that asks at least the user or another party involved in the real time communication to signal if there is a desire for omitting the recording. As another example, the opt out mechanism comprises a distinct, respective, physically actuatable opt out selector apparatus located on an exterior of the device.

Preferably, the device comprises a last-communication rewind mechanism for replay of at least a part, e.g., the last 5 minutes, of the communication recorded most recently. For example, the last-communication rewind mechanism comprises a distinct, respective, physically actuatable selector mechanism located on an exterior of the device to retrieve this part. As another example, the device is voice-controllable and the rewind mechanism is activated upon a specific voice command, in order to enable hands-free operation. The storage of the last N minutes is achieved, e.g., through a circular buffer that starts overwriting itself when full.

An embodiment of the device comprises a thumbwheel for scrolling through recorded communications. A thumbwheel enables easy operation while the device is being held in one hand.

The invention is particularly, but not exclusively, relevant to a device as discussed above that comprises a mobile phone.

An embodiment of the invention is represented by a method for offering a service to subscribers. The method comprises enabling automatic, or default, recording of at least part of a real-time communication initiated or accepted by at least one subscriber. The method comprises enabling playback of subscriber-selected ones of the recorded real-time communications, responsive to at least one subscriber request. In this manner, the recording and storage can be delegated to a network, e.g., a dedicated server on a communication network. As a result, the communication device can be kept lean, and legacy devices can make use of the service. The network enables organizing the recorded communications for retrieval and playback by at least one subscriber. For example, a first subscriber would like to have his/her recordings organized according to time: the recordings most recently made are presented at the top of a list. Another subscriber likes to organize the recordings according to caller-ID. Yet another subscriber likes to store the recordings in an audio format, whereas still another subscriber wants to have the recordings stored in a text format, created through automatic transcription from audio using speech recognition software. A specific subscriber may want to have the option to be able to organize or represent the recordings in a variety of ways, examples of which are discussed above, dependent on his/her needs of the moment. A proper user interface (e.g., graphical or voice controlled) then enables the subscriber to select the mode of organization or representation. As the recording, processing and storage is delegated to a dedicated server, quality of the recording, processing and organizing can be optimized and/or customized. These activities need not be compromised either, as the dedicated server is professionally maintained by the service provider using state-of-the art software to implement the service.

The service preferably comprises offering subscribers and/or their interlocutors an opt-out feature so that given ones of their communications will not be recorded. The service preferably enables the subscriber to select a portion of the real time communication for recording. For example, pushing a button on the device during the communication automatically activates the recording of the succeeding portion of the communication, until the button is released.

The service preferably comprises offering subscribers a last-communication rewind feature for retrieval of a copy of at least part of the real time communication recorded most recently.

An implementation of the invention uses a module with a storage for coupling with the communication device for enabling automatic recording of the real time communication in response to a user of the device initiating or accepting the real time communication. The module is coupled galvanically, electrically or in a wireless manner with the device. Preferably, the module is controllable via a user-interface of the device. For example, a certain key or pattern of keys is reserved for user-interaction with the module to implement, e.g., scrolling through the communication stored on the module, or replaying the communication most recently recorded, or to activate the recording during a real time communication upon a user input. The module preferably, comprises at least one organizational mechanism for organizing the recorded communications in a retrievable form for the user. The module preferably comprises an opt-out mechanism adapted to exempt a particular communication from recording.

The invention also relates to a storage medium readable by a data processing device. The medium carries software adapted to perform operations comprising: detecting initiation or acceptance of a live communication by a user of a consumer electronics communication device; and recording the live communication, preferably under user-determined or selectable conditions. The software may also enable to forward the recording to a remote destination, e.g., determined by default or specified by the user or the communication system. Further objects and advantages will be apparent in the following.

### BRIEF DESCRIPTION OF THE DRAWING

The invention will now be described by way of non-limiting example with reference to the following drawings, wherein:

FIG. 1 is a schematic diagram of a device in accordance with the invention.

FIG. 2 shows a network embodiment.

FIG. 3 is a flowchart of certain operations in accordance with the invention.

FIG. 4 is a block diagram of an implementation of the invention in a cell phone.

### DETAILED DESCRIPTION OF THE PREFERRED EMBODIMENTS

The term “communication” shall be used herein to include telephone calls, whether audio, video, or multimedia in nature, and whether or not occurring via conventional telephonic devices or via the Internet or another data network. The term “conversation” shall be synonymous with communication and shall not exclude non-audio media.

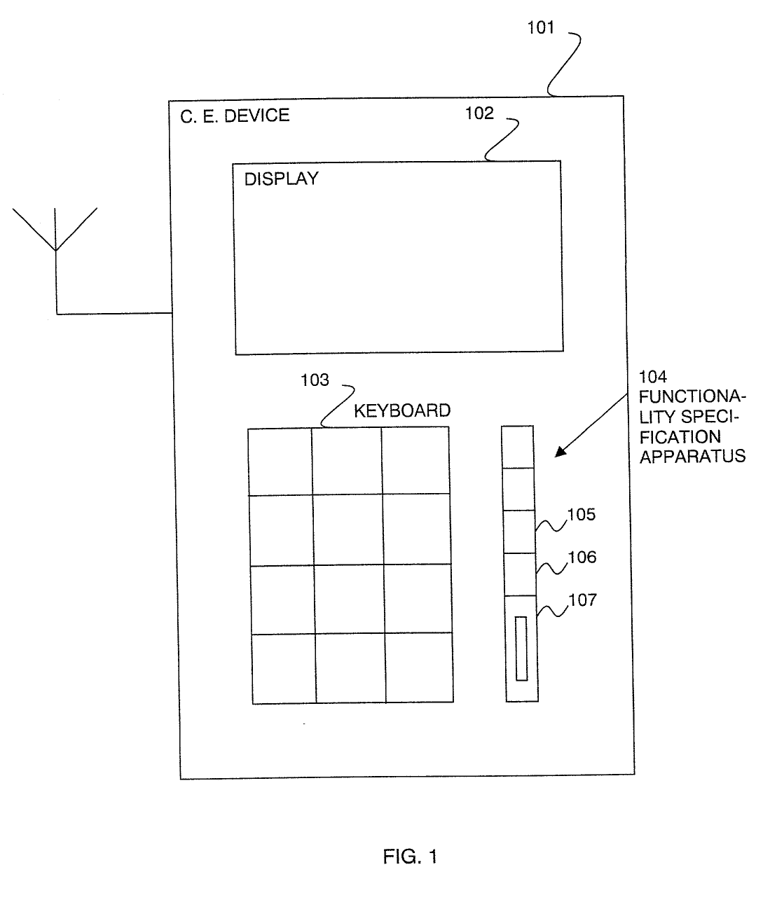

FIG. 1 is a schematic diagram of a consumer electronics device 101 in accordance with the invention. The particular consumer electronics device pictured is a mobile phone. However, the invention is equally applicable to other types of phones, including videophones, or other real-time communications devices, which might include personal computers connected to the Internet. Visible in the diagram are a display 102, a keypad 103 and additional functionality specification apparatus 104. The functionality specification apparatus 104 shown includes an opt-out-of-recording button 105, a last-conversation-rewind button 106, and a thumb wheel 107, which may be in accordance with U.S. patent application Ser. No. 09/780,229 referred to above. These functionality specification devices may be fixed function or may be programmable. Other options for specification of functionality, such as touch screens or pointer devices, are well known to those of ordinary skill in the art and may be readily substituted for the apparatus shown.

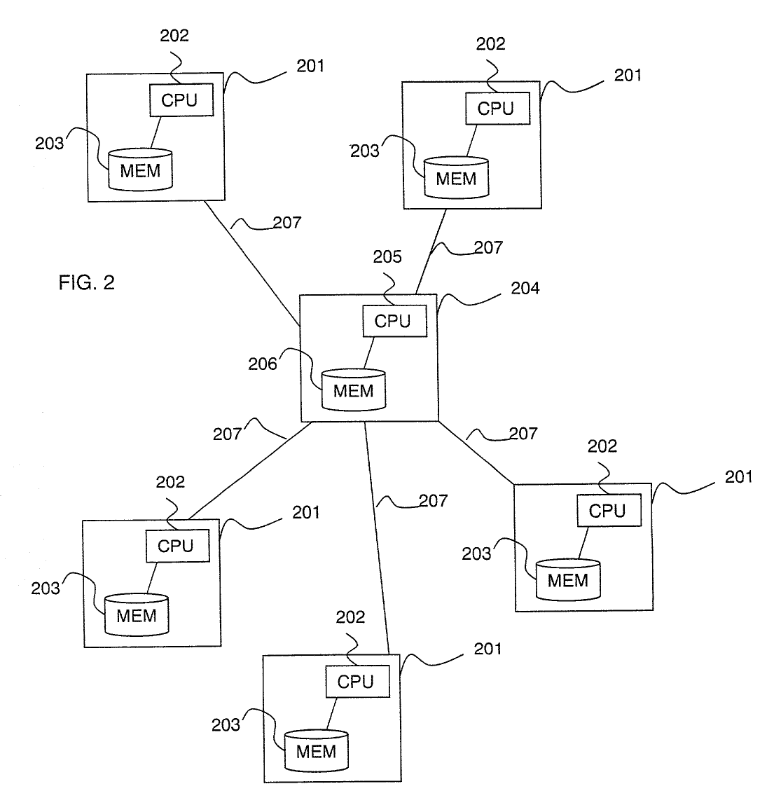

FIG. 2 shows a network embodiment of the invention. A plurality of consumer electronics devices 201 are networked to a central server 204. The server 204 includes a memory 206 and a processor 205. Each consumer electronics device 201 also includes a processor 202 and a memory 203. The consumer electronics devices 201 include real time communication devices, such as the cell phone of FIG. 1, any other type of phone, a personal computer, or a television with a set top box. The network may include a telephone network, a LAN, the Internet, or any other type of analog or digital network. The connections 207 may be wired or wireless.

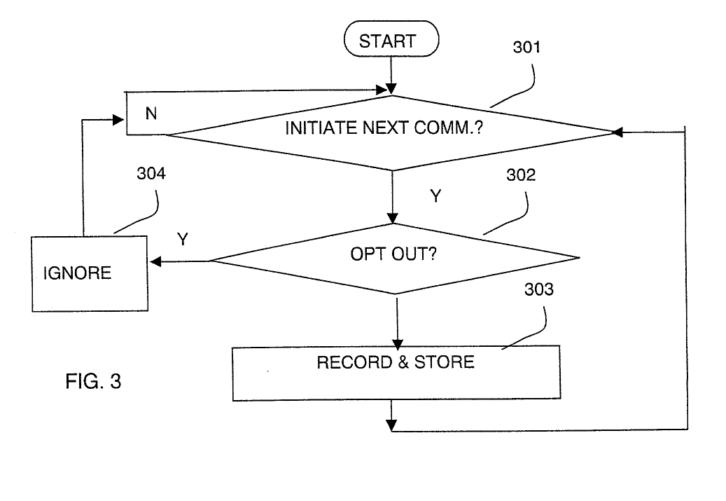

FIG. 3 is a flow chart showing operation of the invention. These operations may occur in a local processor 202, or in a central processor 205 for a network, or they may be distributed between the local processor and the network server.

At 301 it is tested whether a communication is started. Typically, communication is started when the user answers the phone or when the user makes a phone call. It may or may not be desirable to begin recording as soon as the user starts using the phone. A call can be detected in response to hearing tones transmitted from the phone. It may be preferable to wait until an actual two-way communication is established, either when a remote user has picked up the phone or when the voice mail of the remote user has answered. For instance, if the user initiates the call, recording could start when a voice is detected on the other end.

As used herein, the term “remote user” does not necessarily mean that the other user is at a great distance. The remote user might be just down the hall from the first user. The term “remote user” means a user other than the one who is actually using the device that is originating the subject recording. The remote user need not have any control over the same device or have a compatible device.

At 302 it is tested whether anyone has opted out of recording. Opting out may be in the form of pressing of the button 105 by the user. This button is, for example, of the sort that needs to be pushed for each call, or it may be of the sort that once pushed stays down until it is pushed again. Or, there may be a programmable opt out option in the local communication device or in the network.

In addition, laws in some countries may require that the remote user be given the opportunity to opt out of recording. This can be achieved, e.g., by automatically prompting the remote user to press some key on his or her keypad prior to beginning speaking if recording is not desired.

If opt out is selected, then the communication is not selected per 304, and control should be returned to box 301.

If opt out is not selected, the communication is recorded and stored in a usable form at 303. Storing may involve deleting extraneous information such as dial tone and numeric tones. Other extraneous information may be deleted as well. Information may be added to facilitate storing and/or retrieving the recorded call, e.g., time at which the call was made; location where received (location of cell phones can be tracked), etc.

The retrievable form will typically involve some form of organization of the stored data. If a central server 204 is used to store the communications, the organization may take any suitable form, including use of a keyword-oriented database. The following are examples of organization strategies that might be employed by the designer:

order of receipt, e.g. via sequential memory access;

time and date of receipt, e.g. via direct memory access;

some identification of the remote user who participated in the communication, such as phone number; or

folders given user-selected names, with communications being further organized within the folders. The user may have communications first buffered in a cache from which the user can store the recording in the appropriate folder, e.g. manually or through another user input, in the appropriate folder. Fore example, caller-ID can be used to automatically allocate the recording to the proper folder.

The above list only gives a few examples of the many strategies for organizing communications that might be employed by a skilled system and/or user interface designer.

Commonly, various database management techniques will need to be used. For instance, it may be desirable to delete all communications that are older than a certain number of days; or there may be some numeric limit on the number of communications that may be stored.

The designer may choose to store a small portion of the communications, perhaps the most recent one or two, in the local memory 203, while storing the bulk of the communications in a memory 206 associated with a network server. The thumb wheel 107 may advantageously be included to facilitate ease of scrolling through stored phone calls, e.g. as specified in U.S. patent application Ser. No. 09/464,855 mentioned above.

The organization of the communications may, advantageously, offer a number of features. For instance, a “last conversation rewind” feature may be implemented. Such a feature may be activatable, for instance, by button 106, and would allow a user to replay the conversation most recently recorded. Such replay would allow taking notes or clarifying points that the user did not understand. The system preferably offers the following additional capabilities:

the communication may be stored in digital format, e.g. wav format; mp3; etc.

playback controls such as: speed, volume, pause, rewind, fast forward, and so forth,

forwarding conversations or transcoded versions thereof to other users, e.g., as voice mail or as an attachment to e-mail, etc.;

transferring recordings to some additional medium; and

converting stored conversations to text via speech recognition, and forwarding such text via fax or e-mail to a remote user.

Operation of the server 206 may be by a commercial service, for instance by the wireless service provider in the case of mobile phones. The service provider may charge fees for recording, storing and retrieving communications.

The user of the device is preferably enabled to have a call recorded that s/he initiates as well as an incoming call. In one embodiment of the invention, recording starts as soon as dial tones or “ringing” tones are detected. Some countries use different tones for different call status, but the periodicity and frequency spectrum is sufficient to recognize the tones as such. For calls received, starting recording is not a major issue, since the recording can begin when the user answers the phone. For calls initiated at the device, optionally, in a post-processing step (after completion of the call and therefore after recording), the dial tones get deleted under software control to compact the recording. In another embodiment, only a single one of the busy tones or of the calling-in tones gets recorded using a software procedure that, in a repetitive tone sequence, overwrites a previous similar tone with the current one in the recording memory. In yet another embodiment, the abrupt break of the dial tone sequence (when the other party picks up the phone) may have an acoustic fingerprint that serves as a signal to start the recording.

The invention is especially relevant to users of mobile communication devices such as cell phones. Typically, when on the move, the user does not have the opportunity to both juggle the phone and write down some piece of information that he other party is supplying via the phone in real-time. Similarly, when making or receiving a call while driving, the user has to keep his/her eyes on the traffic and has to remain aware of the road conditions. It is therefore advantageous for the user to be able to replay the conversation if and when needed.

The recording can, but need not, be made at the device itself. For example, a cell phone can be equipped with a recording component comprising, e.g., a flash memory card or a hard disk drive unit (HDD) with a small form-factor. The recording component can be accommodated in the cell phone or can be made a separate module that is galvanically or wirelessly coupled with the communication device. In the latter case, the module preferably uses a suitable short-range communication protocol, e.g., Bluetooth. The recording components as a separate module can be an after-market add-on. Play-out of the recording can be through the loudspeaker of the cell phone, of a laptop PC or through another loudspeaker, e.g. the stereo system of the user's car using a suitable connection. Alternatively, the module can be equipped with its own loudspeaker.

The recording can also be (part of) a service on a communication network. For example, the user can lease storage space on the network for buffering of the recordings, e.g., as is similarly being done for voice mails. An application server processes the communication information and converts it to a digital format suitable for a sound file within this context and for the expected quality, e.g., using the wav format. Selecting a dedicated telephone number or other unique identifier, e.g. a URL, gives the user access to his/her recordings. Alternatively to the “last conversation rewind button” described above, the communication device or recording component may have other dedicated buttons or user input interfaces to initiate the retrieval of one or more of the recordings from the network in a user-friendly manner. Preferably, user-access to stored recordings is through an authentication process, e.g., using a password or other unique identifier of the user and/or of the communication device. In case the recordings are stored on the network, the communication device may serve as a controller to have these recordings made and/or retrieved from the network. Alternatively, or in addition, the recordings, either as audio data or transcribed text data, are retrievable from the network from another device, e.g., laptop or desktop PC with the proper connection hardware and software.

The recordings are preferably stored in digital form, possibly after sampling an analog signal. In this manner, compression techniques can be used to save memory space. Digital compression also saves bandwidth when forwarding the recording, e.g. as an attachment to an e-mail or as a stand-alone compressed sound file for use among audio-based communication devices.

Caller-ID or other profiling information (e.g. time of the day, geographic location, day of the week, etc.) may be used to select for which communications to skip the recording or to explicitly carry out the recording.

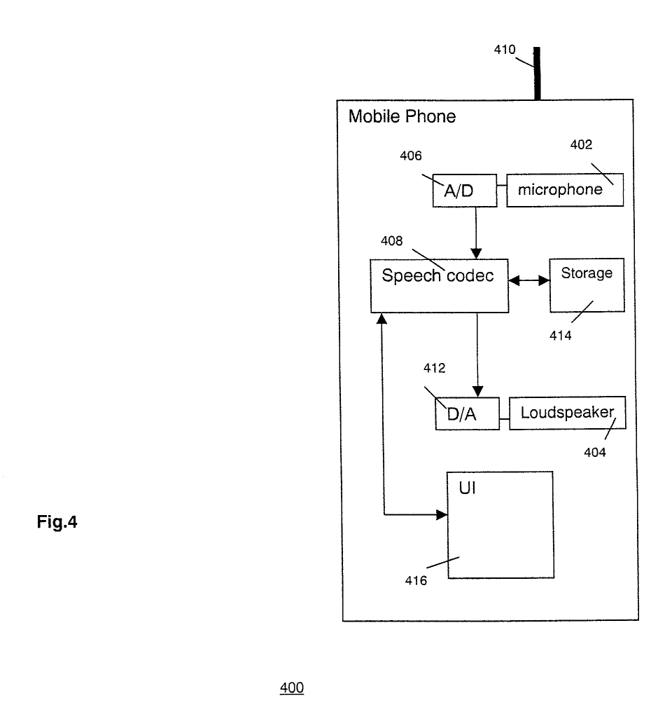

FIG. 4 is a block diagram of a cell phone 400 according to the invention. Cell phone 400 comprises a microphone 402 and a loudspeaker 404. The analog signal from microphone 402 gets sampled and converted to a digital format in A/D 406. The digitized speech is then supplied to a speech codec 408. As known, the digitized speech gets coded for transmission via antenna 410, preferably in terms of parameters descriptive of the speech in order to minimize bandwidth requirements of the transmission. The parameters transmitted enable reconstruction of the speech at the receiving end. Similarly, the signal received at antenna 410 describes the speech input from the remote party in terms of parameters that get processed by codec 408, converted to an analog signal by D/A 412 for play-out via loudspeaker 404. This type of processing is known in the art of digital cell phones. Cell phone 400 comprises a storage 414 that stores the parameters representative of the speech input by the user via microphone 402, and the parameters representative of the speech signal received from the remote user and rendered by loudspeaker 404 in normal operational use of phone 400. Now, for a rewind of the conversation recorded, the parameters stored in storage 414 get supplied to codec 408. Codec 408 then reconstructs the digitized conversation and has it rendered by loudspeaker 404. A user interface (UI) 416 is provided for user control of the rewind.

The data stored in storage 414 thus represents a conversation recorded. In a simple implementation of the invention, storage 414 comprises a FIFO and stores an amount of data equivalent to, e.g., one minute or a few minutes of conversation before a stored part gets overwritten. This enables or facilitates an instant rewind. This data can be sent, or otherwise be made available, to rendering software emulating or representing codec 408. For example, the user could copy or download the content of storage 414 onto a PDA, a set top box or a laptop, and have it rendered locally using codec software combined with speech-to-text conversion software, commercially available. The user could also have the data per recorded conversation stored at the laptop or PDA and transfer it as a file, e.g., as an email attachment.

In summary, the means of processing of the speech is already available at the digital cell phone, and little overhead is needed to implement the recording, automatic or user-selective, and the user-control (opt-out; record portion of current conversation) according to the invention.

The above invention addresses the recording of real time communications. Such communications are volatile, and recording has its use and advantages as explained above. This concept can be expanded to cover the functionality of a Personal Logbook. The user carries a capturing device (e.g., a microphone, a solid state camera) that captures audible and/or visual impressions and/or context information for being stored. The information is preferably stored with time stamps and/or location stamps. In the latter case, a GPS system or another location-finding technology (e.g., beacons) provides the data for the geographic location of the user at the time of the recording that particular piece of information. The collection of recordings forms a personal log or diary/journal. Capturing can be continuous, event-triggered (e.g., heart-beat of the user, detection of a specific sound, coming within range of a specific object, etc.), user-controllable (voice activated, push-button) or controllable by another party. In the latter case, a child can be given such a capturing device, integrated within a piece of clothing or bicycle. The device can be remotely activated by the parent at any time. The device sends the captured data to a remote server or stores it locally for download and post-processing later on.

Another example of volatile information exchange is Instant Messaging. Applying again the concept of the current invention, the string of messages, displayed in an Instant Messaging application or Chat Room application, gets copied to a non-volatile memory (e.g., HDD or solid state memory) for retrieval later on, e.g., automatically or upon specific user-input. In an automatic mode, the user may have specified in advance the size of memory to be allocated to the recording, similarly to the last 5-minute recording in the examples described above for the CE communication device. Currently, Instant Messaging text is available in the frame buffer of the PC for scrolling purposes, but there is no more permanent storage feature available to review the communication off-line.

From reading the present disclosure, other modifications will be apparent to persons skilled in the art. Such modifications may involve other features which are already known in the design, manufacture and use of devices for recording and retrieving real time communications and which may be used instead of or in addition to features already described herein. Although claims have been formulated in this application to particular combinations of features, it should be understood that the scope of the disclosure of the present application also includes any novel feature or novel combination of features disclosed herein either explicitly or implicitly or any generalization thereof, whether or not it mitigates any or all of the same technical problems as does the present invention. The applicants hereby give notice that new claims may be formulated to such features during the prosecution of the present application or any further application derived therefrom.

The word “comprising”,“comprise”, or “comprises” as used herein should not be viewed as excluding additional elements. The singular article “a” or “an” as used herein should not be viewed as excluding a plurality of elements.

What is claimed is:

1. A consumer electronics communication device comprising:
a first functionality adapted to enable real-time communication via the device; and
a second functionality adapted to enable automatic recording of at least part of the real time communication in response to a user of the device initiating or accepting the real time communication.

2. The device of claim 1, wherein the first functionality comprises at least one user interface mechanism adapted to provide real-time audio and/or visual information to a user and to receive real-time audio and/or visual information from the user.

3. The device of claim 1, comprising a user input to enable the user to select a portion of the real-time communication for the recording.

4. The device of claim 1, comprising at least one organizational mechanism for organizing the recorded communications in a retrievable form for the user.

5. The device of claim 1, comprising an onboard storage for storing at least part of the recorded communication.

6. The device of claim 1, comprising an output for transmitting a signal to a storage, the signal being representative of the real time communication for being recorded at the storage

7. The device of claim 1, comprising an opt-out mechanism adapted to exempt a particular communication from being recorded.

8. The device of claim 7, wherein the opt-out mechanism comprises a prompter that asks at least the user or another party involved in the real time communication to signal if there is a desire for omitting the recording.

9. The device of claim 7, wherein the opt-out mechanism comprises a distinct, respective, physically actuatable opt out selector apparatus located on an exterior of the device.

10. The device of claim 1, comprising a last-communication rewind mechanism for replay of at last part of the communication recorded most recently.

11. The device of claim 10, wherein the last-communication rewind mechanism comprises a distinct, respective, physically actuatable selector mechanism located on an exterior of the device.

12. The device of claim 1, comprising a thumbwheel for scrolling through recorded communications.

13. The device of claim 1, wherein the device comprises a mobile phone functionality.

14. A method comprising offering a service, the method comprising:
enabling automatic recording of at least part of a real-time communication initiated or accepted by at least one subscriber; and
responsive to at least one subscriber request, enabling playback of subscriber-selected ones of recorded real-time communications.

15. The method of claim 14, comprising organizing the recorded communications for retrieval and playback by at least one subscriber.

16. The method of claim 14, comprising offering subscribers and/or their interlocutors an opt-out feature so that given ones of their communications will not be recorded.

17. The method of claim 14, enabling the subscriber to select a portion of the real time communication for recording.

18. The method of claim 14, comprising offering subscribers a last-communication rewind feature for enabling to retrieve at last part of a copy of the real time communication recorded most recently.

20. For use with a consumer electronics communication device that enables real-time communication via the device: a module with a storage for coupling with the device for enabling automatic recording of the real time communication in response to a user of the device initiating or accepting the real time communication.

21. The module of claim 20, for galvanic coupling with the device.

22. The module of claim 20, for coupling with the device using in a wireless manner.

23. The module of claim 20, being controllable via a user-interface of the device.

24. The module of claim 20, comprising at least one organizational mechanism for organizing the recorded communications in a retrievable form for the user.

25. The module of claim 20, comprising an opt out mechanism adapted to exempt a particular communication from recordation.
